(19) United States
(12) Patent Application Publication
(10) Pub. No.: US 2026/0331373 A1
(43) Pub. Date: Oct. 22, 2026

(54) MULTILAYER CERAMIC ELECTRONIC COMPONENT, AND PRODUCTION METHOD OF THE MULTILAYER CERAMIC ELECTRONIC COMPONENT

(71) Applicant: TAIYO YUDEN CO., LTD., Tokyo (JP)

(72) Inventors: Shota YAMANAKA, Tokyo (JP); Tomoki SAKAI, Tokyo (JP); Tomoaki NAKAMURA, Tokyo (JP); Ayumi SHIROTA, Tokyo (JP); Satoshi KOBAYASHI, Tokyo (JP)

(21) Appl. No.: 19/564,687

(22) Filed: Mar. 12, 2026

(30) Foreign Application Priority Data
Mar. 27, 2025 (JP) 2025-054557

(51) Int. Cl. H01G 4/258; H01G 4/232; H01G 4/248; H01G 4/30

(52) U.S. Cl. CPC H01G 4/258; H01G 4/232; H01G 4/248; H01G 4/30

(57) ABSTRACT

A multilayer ceramic electronic component is provided and includes a body including a plurality of internal electrodes and a plurality of dielectric layers, laminated in an alternating manner a pair of end surfaces, four surfaces connected to the end surfaces, and corners between the end surfaces and the four surfaces connected to the end surfaces, in which the dielectric layers include a ceramic as a main component; a pair of metal base layers extending from the end surfaces to a portion of the four surfaces; an insulating layer including glass, and disposed over the metal base layers that are over the end surfaces of the body and/or the four surfaces of the body; and a metal cover layer covering at least a portion of the metal base layers and at least a portion of the insulating layer, and contacting the metal base layers at the corners of the body.

### CROSS-REFERENCE TO RELATED APPLICATIONS

This patent application is based on and claims priority to Japanese Patent Application No. 2025-054557 filed on Mar. 27, 2025, the entire contents of which are incorporated herein by reference.

### TECHNICAL FIELD

The present disclosure relates to a multilayer ceramic electronic component, and a production method of the multilayer ceramic electronic component.

### BACKGROUND

After being mounted on a board, a multilayer ceramic capacitor may form cracks, for example, due to deflection of the board, or stress caused by change in temperature. A multilayer ceramic capacitor having cracks tends to cause failures, such as reduction in capacitance, reduction in insulation resistance, reduction in connection strength to the board, and the like.

A known multilayer ceramic capacitor in which formation of cracks can be suppressed is, for example, a multilayer ceramic capacitor including a flexible conductive resin layer in a portion of an external electrode, and the conductive resin layer functions to mitigate stress applied to a ceramic body and the external electrode (see Patent Document 1).

### RELATED ART DOCUMENT

### Patent Document

Patent Document 1: Japanese Laid-Open Patent Application Publication No. 2021-034440

### SUMMARY

An embodiment of the present disclosure is a multilayer ceramic electronic component. The multilayer ceramic electronic component includes: a body including a plurality of internal electrodes and a plurality of dielectric layers, laminated in an alternating manner, a pair of end surfaces from which the laminated internal electrodes are respectively exposed in an alternating manner and which face each other in a first direction, four surfaces connected to the end surfaces, and corners between the end surfaces and the four surfaces connected to the end surfaces, in which the dielectric layers include a ceramic as a main component; a pair of metal base layers extending from the end surfaces to a portion of the four surfaces; an insulating layer including glass, and disposed over the metal base layers that are over the end surfaces of the body, the four surfaces of the body, or both the end surfaces of the body and the four surfaces of the body; and a metal cover layer covering at least a portion of the metal base layers and at least a portion of the insulating layer, and contacting the metal base layers at the corners of the body.

Another embodiment of the present disclosure is a production method of a multilayer ceramic electronic component. The production method of the multilayer ceramic electronic component includes: providing a body including a plurality of internal electrodes and a plurality of dielectric layers, laminated in an alternating manner, a pair of end surfaces from which the laminated internal electrodes are respectively exposed in an alternating manner and which face each other in a first direction, four surfaces connected to the end surfaces, and corners between the end surfaces and the four surfaces connected to the end surfaces, in which the dielectric layers include a ceramic as a main component; forming a pair of metal base layers extending from the end surfaces to a portion of the four surfaces; forming an insulating layer including glass and disposed over the metal base layers that are over the end surfaces of the body, the four surfaces of the body, or both the end surfaces of the body and the four surfaces of the body; and forming a metal cover layer covering at least a portion of the metal base layers and at least a portion of the insulating layer, and contacting the metal base layers at the corners of the body.

### BRIEF DESCRIPTION OF THE DRAWINGS

FIG. 1 is a partial cross-sectional perspective diagram illustrating an example of a multilayer ceramic capacitor according to a first embodiment of the present disclosure.

FIG. 2 is a schematic cross-sectional diagram illustrating a cross section taken along the line A-A in FIG. 1.

FIG. 3 is a schematic cross-sectional diagram illustrating a cross section taken along the line B-B in FIG. 1.

FIG. 4 is a cross-sectional diagram illustrating an example of a multilayer ceramic capacitor according to a second embodiment of the present disclosure.

FIG. 5 is a schematic explanatory diagram of a coverage of an insulating layer on a metal base layer.

FIG. 6A is a schematic cross-sectional diagram illustrating an example of a multilayer ceramic capacitor according to a third embodiment of the present disclosure.

FIG. 6B is an enlarged diagram of an end portion in FIG. 6A.

FIG. 7 is a schematic cross-sectional diagram illustrating an example of a multilayer ceramic capacitor according to a fourth embodiment of the present disclosure.

FIG. 8 is a schematic cross-sectional diagram illustrating an example of a multilayer ceramic capacitor according to a fifth embodiment of the present disclosure.

FIG. 9 is a schematic cross-sectional diagram illustrating an example of a multilayer ceramic capacitor according to a conventional comparative embodiment.

FIG. 10 is a schematic explanatory diagram illustrating mounting of the multilayer ceramic capacitor according to the conventional comparative embodiment on a circuit board.

FIG. 11 is a flowchart of a production method of a multilayer ceramic capacitor according to an embodiment of the present disclosure.

### DETAILED DESCRIPTION

Conventional multilayer ceramic electronic components have a problem with insufficiently suppressed crack formation due to insufficient mechanical strength.

According to the present disclosure, it is possible to provide a multilayer ceramic electronic component with suppressed crack formation during mounting on a circuit board and during use; and a production method of the multilayer ceramic electronic component.

Hereinafter, embodiments of the present disclosure will be described in detail. The embodiments are not limited by the following description, and may be appropriately modified within a range not departing from the intent of the present disclosure. In the present specification, a numerical range indicated by “value A to value B” means that the value A and the value B are included in the numerical range as the lower limit and the upper limit, respectively, unless otherwise specified.

In the present specification and drawings, components having substantially the same functional configurations are denoted by the same signs, and duplicate descriptions thereof may be omitted. Also, in the present specification and drawings, the number, position, size, shape, and the like of each component are not limited to the embodiments of the present disclosure, and may be a preferable number, position, size, shape, and the like in the embodiments of the present disclosure. In the drawings, an X axis, a Y axis, and a Z axis, orthogonal to each other, are shown as appropriate. The X axis, Y axis, and Z axis define a fixed coordinate system fixed to the multilayer ceramic electronic component.

### Multilayer Ceramic Electronic Component

### (First Embodiment)

A multilayer ceramic electronic component according to a first embodiment includes: a body including a plurality of internal electrodes and a plurality of dielectric layers, laminated in an alternating manner, a pair of end surfaces from which the laminated internal electrodes are respectively exposed in an alternating manner and which face each other in a first direction, four surfaces connected to the end surfaces, and corners between the end surfaces and the four surfaces connected to the end surfaces, in which the dielectric layers include a ceramic as a main component; a pair of metal base layers extending from the end surfaces to a portion of the four surfaces; an insulating layer including glass, and disposed over the metal base layers that are over the four surfaces of the body; and a metal cover layer covering at least a portion of the metal base layers and at least a portion of the insulating layer, and contacting the metal base layers at the corners of the body. The multilayer ceramic electronic component according to the first embodiment may further include other layers or members, if necessary.

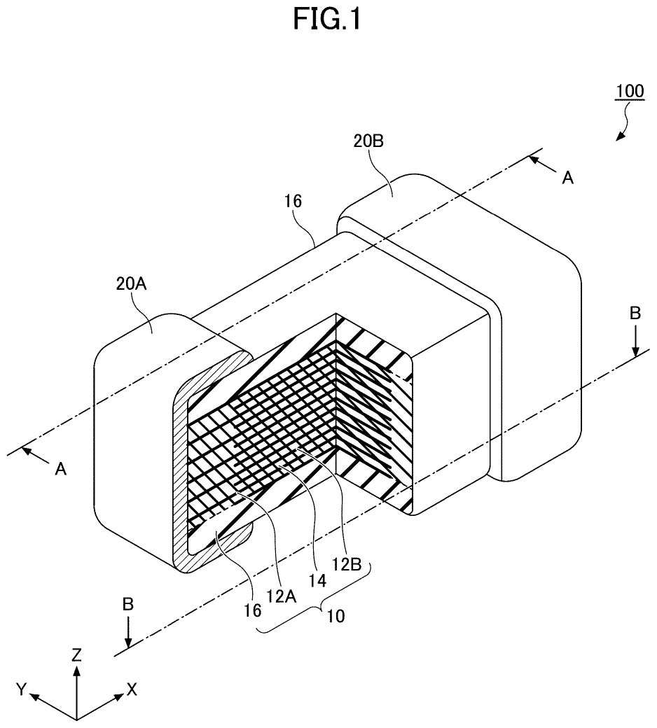

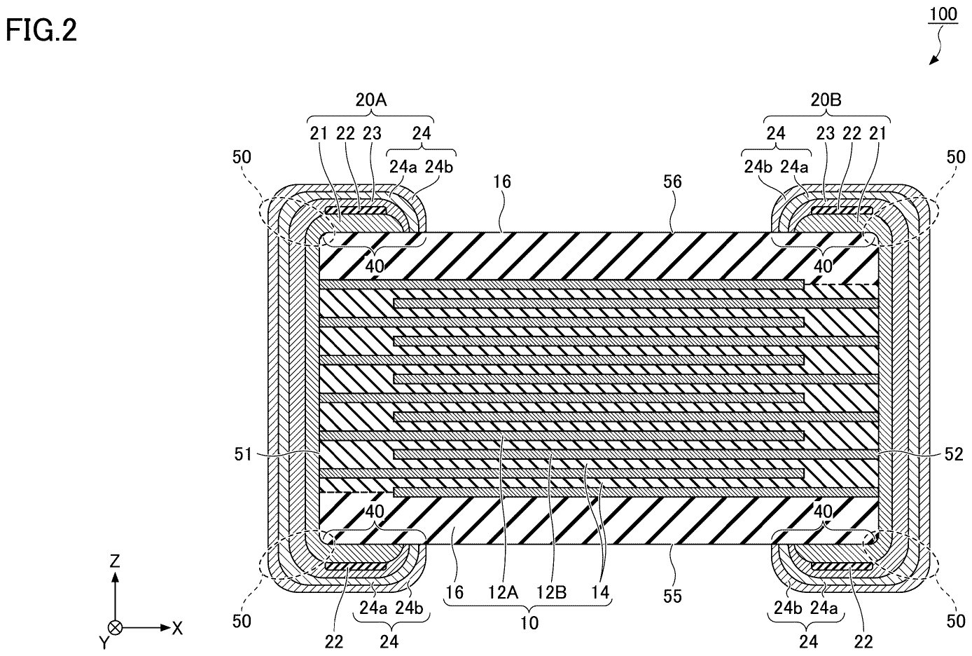

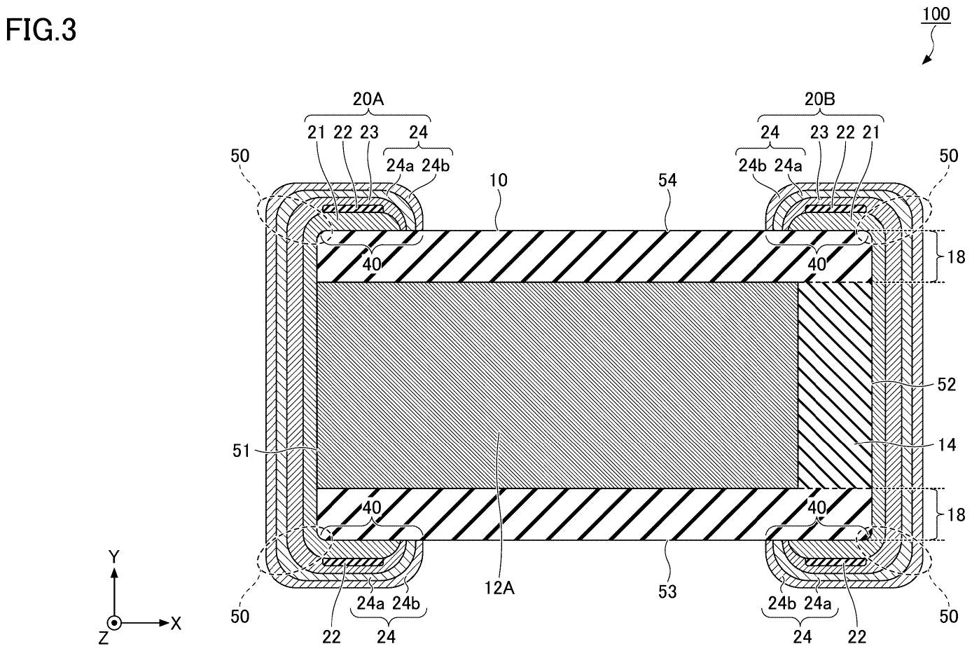

A multilayer ceramic capacitor will be described as an example of the multilayer ceramic electronic component. FIG. 1 is a partial cross-sectional perspective diagram illustrating a multilayer ceramic capacitor 100 according to the first embodiment. FIG. 2 is a schematic cross-sectional diagram illustrating a cross section taken along the line A-A in FIG. 1. FIG. 3 is a schematic cross-sectional diagram illustrating a cross section taken along the line B-B in FIG. 1.

In the present disclosure, an X-axis direction (first direction) is a lengthwise direction of a body 10, i.e., a direction in which a pair of end surfaces 51 and 52 of the body 10 face each other. A Z-axis direction (second direction) is a lamination direction in which dielectric layers 14 and internal electrodes 12A and 12B are laminated, i.e., a direction in which a bottom surface 55 and a top surface 56 of the body 10 face each other. A Y-axis direction (third direction) is a widthwise direction of the internal electrodes 12A and 12B, i.e., a direction in which a pair of side surfaces 53 and 54 of the body 10 face each other. The X-axis direction, Y-axis direction, and Z-axis direction cross each other or are orthogonal to each other. That is, the four surfaces connected to the end surfaces 51 and 52 are the bottom surface 55, the top surface 56, and the pair of side surfaces 53 and 54.

The multilayer ceramic capacitor 100 includes the body 10 with a substantially rectangular parallelepiped shape, and external electrodes 20A and 20B. The body 10 includes the dielectric layers 14, the internal electrodes 12A and 12B, and dielectric cover layers 16. The internal electrodes 12A and the internal electrodes 12B are laminated in an alternating manner. One of the dielectric layers 14 is disposed between one of the internal electrodes 12A and one of the internal electrodes 12B, the one internal electrode 12A and the one the internal electrode 12B being next to each other. The outermost layers in the Z-axis direction of a laminate, in which the dielectric layers 14 and the internal electrodes 12A and 12B are laminated, are the internal electrodes 12A and 12B. The bottom and top surfaces of the laminate are covered by the dielectric cover layers 16. Regions sandwiching the internal electrodes 12A and 12B in the Y-axis direction are side margin regions 18.

The internal electrodes 12A and 12B are respectively exposed from the end surfaces 51 and 52, in an alternating manner. The internal electrodes 12A are exposed from the end surface 51, and the internal electrodes 12B are not exposed from the end surface 51. The internal electrodes 12B are exposed from the end surface 52, and the internal electrodes 12A are not exposed from the end surface 52. That is, the internal electrodes 12A and 12B are connected to the different end surfaces 51 and 52.

The external electrode 20A is in contact with the internal electrodes 12A exposed from the body 10 at the end surface 51. The external electrode 20B is in contact with the internal electrodes 12B exposed from the body 10 at the end surface 52. In addition to the end surface 51, the external electrode 20A covers the side surfaces 53 and 54, and end portions 40 of the bottom surface 55 and the top surface 56 in a −X direction. The external electrode 20B is in contact with the internal electrodes 12B at the end surface 52. In addition to the end surface 52, the external electrode 20B covers the side surfaces 53 and 54, and the end portions 40 of the bottom surface 55 and the top surface 56 in a +X direction. The end portions 40 are portions in the vicinity of the end surfaces 51 and 52 among the surfaces connected to the end surfaces 51 and 52 of the body 10.

As an example, the external electrode 20A may be used as a positive electrode, and the external electrode 20B may be used as a negative electrode. For distinguishing the external electrode 20A and the external electrode 20B from each other, it is preferable to provide the external electrodes 20A and 20B with distinctions in the outer appearances, such as markings or the like.

Each of the external electrodes 20A and 20B includes a metal base layer 21, an insulating layer 22, and a metal cover layer 23. Also, preferably, each of the external electrodes 20A and 20B further includes a plating layer 24.

The metal base layer 21 extends from each of the end surfaces 51 and 52 to a portion of the bottom surface 55, the top surface 56, and the side surfaces 53 and 54, which are the four surfaces.

The insulating layer 22 is disposed over the metal base layer 21 at the four surfaces of the body 10. Both ends of the insulating layer 22 are in contact with the metal cover layer 23.

The metal cover layer 23 covers the insulating layer 22 and at least a portion of the metal base layer 21, and is in contact with the metal base layer 21 at corners 50 of the body 10. That is, the insulating layer 22 is not disposed at the corners 50 of the body 10. The ends of the metal cover layer 23 disposed at the four surfaces of the body 10 are in contact with the body 10.

The plating layer 24 covers the metal cover layer 23. The ends of the plating layer 24 disposed over the four surfaces of the body 10 are in contact with the body 10 farther outward than the ends of the metal cover layer 23.

As illustrated in a comparative embodiment described below, when a circuit board is deflected during mounting of a conventional multilayer ceramic capacitor 200 on the circuit board, stress caused by the deflection is applied to the external electrodes 20A and 20B from a mounting surface of the multilayer ceramic capacitor 200, i.e., from the bottom surface 55. Also, the stress caused by the deflection may be further transmitted to the end surfaces 51 and 52 of the body 10. As a result, cracks may occur in the body 10 from the end portions 40. Further, in an environment in which the temperature repeatedly changes between a high temperature and a low temperature, the difference in thermal expansion coefficient between the conventional multilayer ceramic capacitor 200 and the circuit board applies thermal stress to the soldered portion in the conventional multilayer ceramic capacitor 200, resulting in formation of cracks in the body 10 mainly from the end portions 40. Disadvantageously, the formation of the cracks causes reductions in breakdown voltage and withstand voltage.

The multilayer ceramic capacitor 100 according to the first embodiment includes, between the metal base layer 21 and the metal cover layer 23 each having ductility, the glass-including insulating layer 22 with a hardness higher than those of the metal base layer 21 and the metal cover layer 23. Thus, the external electrodes 20A and 20B can have both appropriate flexibility and appropriate strength, and can effectively suppress the formation of cracks due to the stress caused by the deflection of the board during mounting on the circuit board and by the change in temperature. In particular, the insulating layer 22 disposed over the metal base layer 21 over at least one of the four surfaces of the body 10 effectively suppresses the formation of cracks in the body 10 from the end portions 40 due to stress caused by the change in temperature. The metal cover layer 23 is in contact with the metal base layer 21 at the corners 50 of the body 10, i.e., the insulating layer 22 including glass is not disposed at the corners 50. This can suppress contact resistance between the metal base layer 21 and the metal cover layer 23. Further, in the multilayer ceramic capacitor 100 according to the first embodiment, the ends of the metal cover layer 23 disposed over the four surfaces of the body 10 are in contact with the body 10, and the insulating layer 22 disposed over the four surfaces of the body 10 is not exposed. Thus, adhesion to the plating layer 24 is excellent.

In the present disclosure, the outer periphery defining each member is preferably formed as a flat surface. However, the outer periphery does not necessarily need to be a strictly flat surface as long as the outer periphery is recognized to be flat when viewed as a whole. The outer periphery includes, for example, a surface with minute irregularities, and a surface with a gently curved shape in a predetermined range.

No particular limitation is imposed on the size of the multilayer ceramic capacitor 100. The size of the multilayer ceramic capacitor 100 may be, for example: 0.25 millimeters (mm) in length, 0.125 mm in width, and 0.125 mm in height; 0.4 mm in length, 0.2 mm in width, and 0.2 mm in height; 0.6 mm in length, 0.3 mm in width, and 0.3 mm in height; 1.0 mm in length, 0.5 mm in width, and 0.5 mm in height; 3.2 mm in length, 1.6 mm in width, and 1.6 mm in height; and 4.5 mm in length, 3.2 mm in width, and 2.5 mm in height. However, the above-listed sizes of the multilayer ceramic capacitor 100 are merely examples, and the size of the multilayer ceramic capacitor 100 is not limited to the above sizes. The size of the multilayer ceramic capacitor 100 may be, for example, as follows: length>width≥height; width>length≥height; height>length≥width; or height>width≥length. For example, the length is the size in the X-axis direction, the width is the size in the Y-axis direction, and the height is the size in the Z-axis direction.

### <Dielectric Layer 14>

The dielectric layers 14 include a ceramic as a main component. The ceramic included in the dielectric layers 14 is, for example, a compound having a perovskite structure represented by a general formula ABO_{3-α}(0≤α≤1). The dielectric layers 14 may further include additives, if necessary.

When the compound having the perovskite structure has a stoichiometric composition, α, indicating an amount deviating from the stoichiometric composition, is 0, and the compound having the perovskite structure is represented by the general formula ABO₃. In the compound having the perovskite structure represented by the general formula ABO₃, α may be greater than 0 and 1 or less. That is, the compound having the perovskite structure represented by the general formula ABO₃ may be more oxygen-deficient than the stoichiometric composition.

In the general formula ABO_{3-α}, “A” is preferably one or more elements selected from the group consisting of Ba (barium), Sr (strontium), Ca (calcium), and Mg (magnesium). In the general formula ABO_{3-α}, “B” is preferably one or more elements selected from the group consisting of Ti (titanium), Zr (zirconium), and Hf (hafnium). In the compound having the perovskite structure represented by the general formula ABO_{3-α}, the elements “A” and “B” are located at the A site and the B site of the perovskite structure, respectively.

Specific examples of the compound having the perovskite structure include one or more selected from the group consisting of barium titanate (BaTiO₃), calcium zirconate (CaZrO₃), calcium titanate (CaTiO₃), strontium titanate (SrTiO₃), magnesium titanate (MgTiO₃), and Ba_{1-x-y}CaₓSr_{y}Ti_{1-z}Zr_{z}O₃ (0≤x≤1, 0≤y≤1, 0≤z≤1) forming a perovskite structure.

Examples of Ba_{1-x-y}CaₓSr_{y}Ti_{1-z}Zr_{z}O₃ include strontium barium titanate, calcium barium titanate, barium zirconate, barium zirconate titanate, calcium zirconate titanate, calcium barium zirconate titanate, and the like. Any of these compounds having the perovskite structure may include oxygen deficiency.

The dielectric layers 14 preferably include barium titanate as the compound having the perovskite structure because barium titanate has especially excellent dielectric characteristics. The dielectric layers 14 may include barium titanate as a main component or may consist of barium titanate. Barium titanate has excellent dielectric characteristics, such as a very high relative dielectric constant, a low dielectric loss, and the like. Therefore, when the dielectric layers 14 include barium titanate as the compound having the perovskite structure, it is possible to increase the electrostatic capacitance of the multilayer ceramic capacitor 100.

In the present disclosure, “main component” means a component that is included in the largest amount in terms of the amount by mole among included components.

Also, the dielectric layers 14 may include, as the main component, the compound having the perovskite structure. For example, the dielectric layers 14 may include the compound having the perovskite structure in an amount of 50% by mole or more, or 90% by mole or more. Alternatively, the dielectric layers 14 may consist of the compound having the perovskite structure.

The dielectric layers 14 may also include an additive as an optional component. No particular limitation is imposed on the additive included in the dielectric layers 14. Examples of the additive included in the dielectric layers 14 include, for example: oxides including one or more elements selected from zirconium (Zr), magnesium (Mg), manganese (Mn), molybdenum (Mo), vanadium (V), chromium (Cr), and rare earth elements (scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb)); oxides including one or more elements selected from cobalt (Co), nickel (Ni), lithium (Li), boron (B), sodium (Na), potassium (K), and silicon (Si); and glass including one or more elements selected from cobalt, nickel, lithium, boron, sodium, potassium, and silicon.

No particular limitation is imposed on the average thickness of the dielectric layers 14. From the viewpoint of increasing the number of laminated layers to increase the electrostatic capacitance while downsizing the multilayer ceramic capacitor 100, for example, the average thickness of the dielectric layers 14 is preferably 5.0 micrometers (μm) or less, more preferably 2.5 μm or less, and further preferably 1.5 μm or less. Also, from the viewpoint of increasing productivity and yield, the average thickness of the dielectric layers 14 is preferably 0.1 μm or more, more preferably 0.2 μm or more, and further preferably 0.3 μm or more. Appropriate combinations of the upper and lower limits of the average thickness of the dielectric layers 14 can be used, and the average thickness of the dielectric layers 14 is preferably 0.1 μm or more and 5.0 μm or less, more preferably 0.2 μm or more and 2.5 μm or less, and further preferably 0.3 μm or more and 1.5 μm or less.

For the evaluation of the average thickness of the dielectric layers 14, as illustrated in FIGS. 1 and 2, the multilayer ceramic capacitor 100 is polished or cut along the Y axis up to the center along the Y axis, thereby preparing a sample including an exposed XZ plane, in which the dielectric layers 14 and the internal electrodes 12A and 12B are laminated. From the exposed XZ plane, two of the dielectric layers 14 located at the center along the Z axis are selected, two of the dielectric layers 14 located at the upper end along the Z axis are selected, and two of the dielectric layers 14 located at the lower end along the Z axis are selected. Here, the dielectric layers 14 are selected from the capacitor portion in which the internal electrodes 12A, the dielectric layers 14, and the internal electrodes 12B are laminated in the Z-axis direction.

Each of the selected dielectric layers 14 is measured for the thickness at the center along the X axis along the first direction, to determine the thickness of the dielectric layer 14. The thicknesses of all the six selected dielectric layers 14 are measured by the same procedure, and the average of the measured thicknesses is calculated. The calculated average is defined as the average thickness of the dielectric layers 14 in the multilayer ceramic capacitor 100. The thicknesses of the dielectric layers 14 can be measured, for example, by a microscope.

### <Internal Electrodes 12A and 12B>

The internal electrodes 12A and 12B include a conductive material. The internal electrodes 12A and 12B may further include a co-existent material, if necessary.

No particular limitation is imposed on the conductive material, and the conductive material may be appropriately selected in accordance with the intended purpose. Examples of the conductive material include, for example: base metals, such as nickel (Ni), copper (Cu), tin (Sn), and the like, and alloys including these; and noble metals, such as platinum (Pt), palladium (Pd), silver (Ag), gold (Au), and the like, and alloys including these. These may be used alone or in combination. Of these, the internal electrodes 12A and 12B preferably include the base metal or the base metal-including alloy as a main component because the production cost can be reduced even if a large number of the internal electrodes 12A and 12B are laminated. More preferably, the internal electrodes 12A and 12B include Ni because the internal electrodes 12A and 12B can be fired simultaneously with the dielectric layers 14, i.e., the production efficiency is high.

The amount of each metal in the internal electrodes 12A and 12B can be confirmed by performing elemental analysis of the internal electrodes 12A and 12B using various measuring devices, and calculating the percentage by number of atoms of each component relative to all the detected elements. Examples of the measuring devices usable for elemental analysis include, for example: an energy dispersive X-ray spectrometer (EDS) or a wavelength dispersive X-ray spectrometer (WDS) attached to a scanning electron microscope (SEM) or a transmission electron microscope (TEM); an electron probe micro analyzer (EPMA); and a laser ablation-inductively coupled plasma mass spectrometer (LA-ICP-MS).

No particular limitation is imposed on the co-existent material. The co-existent material is, for example, a material that is the same as the ceramic serving as the main component of the dielectric layers 14. The co-existent material is preferably a spherical particle. The co-existent material preferably includes the compound having the perovskite structure represented by the general formula ABO_{3-α}(0≤α≤1).

Specific examples of the co-existent material include one or more selected from the group consisting of barium titanate (BaTiO₃), calcium zirconate (CaZrO₃), calcium titanate (CaTiO₃), strontium titanate (SrTiO₃), magnesium titanate (MgTiO₃), and Ba_{1-x-y}CaₓSr_{y}Ti_{1-z}Zr_{z}O₃ (0≤x≤1, 0≤y≤1, 0≤z≤1) forming a perovskite structure.

Examples of Ba_{1-x-y}CaₓSr_{y}Ti_{1-z}Zr_{z}O₃ include strontium barium titanate, calcium barium titanate, barium zirconate, barium zirconate titanate, calcium zirconate titanate, calcium barium zirconate titanate, and the like. Any of the compounds having the perovskite structure may include oxygen deficiency.

No particular limitation is imposed on the particle diameter of the co-existent material, and the particle diameter of the co-existent material is preferably smaller than the thickness of each of the internal electrodes 12A and 12B. From the viewpoint of thinning the internal electrodes 12A and 12B, the particle diameter of the co-existent material is more preferably 10 nanometers (nm) to 100 nm, and further preferably 10 nm to 50 nm.

No particular limitation is imposed on the amount of the co-existent material in the internal electrodes 12A and 12B, and the amount of the co-existent material in the internal electrodes 12A and 12B may be appropriately selected in accordance with the intended purpose.

The amount of the co-existent material in the internal electrodes 12A and 12B is a percentage by mass of the co-existent material when the amount of the conductive material in the internal electrodes 12A and 12B is 100% by mass. The amount of the co-existent material in the internal electrodes 12A and 12B can be calculated from the amount of a raw material used when producing the internal electrodes 12A and 12B.

No particular limitation is imposed on the average thickness of the internal electrodes 12A and 12B. From the viewpoint of increasing the number of laminated layers to increase the electrostatic capacitance while downsizing the multilayer ceramic capacitor 100, for example, the average thickness of the internal electrodes 12A and 12B is preferably 3.0 μm or less, more preferably 1.5 μm or less, and further preferably 0.8 μm or less. Also, from the viewpoint of increasing productivity and yield, for example, the average thickness of the internal electrodes 12A and 12B is preferably 0.1 μm or more, more preferably 0.2 μm or more, and further preferably 0.3 μm or more. Appropriate combinations of the upper and lower limits of the average thickness of the internal electrodes 12A and 12B can be used, and the average thickness of the internal electrodes 12A and 12B is preferably 0.1 μm or more and 3.0 μm or less, more preferably 0.2 μm or more and 1.5 μm or less, and further preferably 0.3 μm or more and 0.8 μm or less.

For the evaluation of the average thickness of the internal electrodes 12A and 12B, as illustrated in FIGS. 1 and 2, the multilayer ceramic capacitor 100 is polished or cut along the Y axis up to the center along the Y axis, thereby preparing a sample including an exposed XZ plane, in which the dielectric layers 14 and the internal electrodes 12A and 12B are laminated. From the exposed XZ plane, two of the internal electrodes 12A and 12B located at the center along the Z axis are selected, two of the internal electrodes 12A and 12B located at the upper end along the Z axis are selected, and two of the internal electrodes 12A and 12B located at the lower end along the Z axis are selected. Here, the internal electrodes 12A and 12B are selected from the capacitor portion.

Each of the selected internal electrodes 12A and 12B is measured for the thickness at the center along the X axis along the first direction, to determine the thickness of each of the selected internal electrodes 12A and 12B. The thicknesses of all the six selected internal electrodes 12A and 12B are measured by the same procedure, and the average of the measured thicknesses is calculated. The calculated average is defined as the average thickness of the internal electrodes 12A and 12B in the multilayer ceramic capacitor 100. The thicknesses of the internal electrodes 12A and 12B can be measured, for example, by a microscope.

### <Dielectric Cover Layer 16>

The composition of the main component ceramic of a dielectric cover layer 16 may be the same as or different from that of the main component ceramic of the dielectric layer 14.

### <Metal Base Layer 21>

No particular limitation is imposed on the metal serving as the main component of the metal base layer 21. The metal serving as the main component of the metal base layer 21 preferably improves electrical conduction between the internal electrodes 11 and the metal base layer 21, and examples of the metal serving as the main component of the metal base layer 21 include, for example: metals, such as copper (Cu), nickel (Ni), titanium (Ti), aluminum (Al), zinc (Zn), and the like; and alloys of two or more of these metals (e.g. an alloy of copper and nickel). These may be used alone or in combination. Of these, the metal base layer 21 preferably includes copper or nickel as the main component, and more preferably includes copper as the main component.

The metal base layer 21 preferably includes, in addition to the main component, a glass component for densification, and a ceramic, such as, for example, a co-existent material for controlling firing properties of the external electrodes 20A and 20B. Examples of the glass component included in the metal base layer 21 include, for example, oxides of barium (Ba), strontium (Sr), calcium (Ca), zinc (Zn), aluminum (Al), silicon (Si), boron (B), and the like. These may be used alone or in combination.

When the metal base layer 21 includes a glass component, the amount of the glass component is preferably 25% by mass or less, and more preferably 15% by mass or less, relative to the total mass of the metal base layer 21.

No particular limitation is imposed on the average thickness of the metal base layers 21, and the average thickness of the metal base layers 21 is preferably 5 μm or more and 100 μm or less, more preferably 10 μm or more and 40 μm or less, and further preferably 20 μm or more and 30 μm or less.

### <Insulating Layer 22>

The insulating layer 22 includes glass, and may further include other components, if necessary. Glass is preferably the main component of the insulating layer 22. Examples of the glass component included in the insulating layer 22 include, for example, oxides of barium (Ba), strontium (Sr), calcium (Ca), zinc (Zn), aluminum (Al), silicon (Si), boron (B), and the like. These may be used alone or in combination. Of these, from the viewpoint of suppressing the formation of cracks during mounting on a circuit board and during use, the insulating layer 22 preferably includes an oxide of silicon (Si), and more preferably includes silicon dioxide.

The amount of the glass in the insulating layers 22 can be confirmed by performing elemental analysis of each insulating layer using various measuring devices, and calculating the percentage by number of atoms of the glass component relative to all the detected elements. Examples of the measuring devices for elemental analysis include those exemplified for the measurement of the amount of each metal in the internal electrodes 12.

The insulating layer 22 may include boron nitride (BN) as a component other than glass.

No particular limitation is imposed on the average thickness of the insulating layers 22, and the average thickness of the insulating layers 22 is preferably 0.1 μm or more and 50 μm or less, more preferably 1 μm or more and 5 μm or less, and further preferably 1 μm or more and 3 μm or less. When the average thickness of the insulating layers 22 is 0.1 μm or more, the hardness of the external electrodes 20A and 20B can be increased. This can increase the mechanical strength against the stress caused by the deflection of the board and the change in temperature, thereby more effectively suppressing the formation of cracks during mounting on a circuit board and during use. When the average thickness of the insulating layers 22 is 50 μm or less, the flexibility of the external electrodes 20A and 20B is not impaired, which can more effectively suppress the formation of cracks during mounting on a circuit board and during use.

The insulating layer 22 may be formed continuously or discontinuously.

### <Metal Cover Layer 23>

The composition of the metal cover layer 23 may be the same as or different from the composition of the metal base layer 21. By using a metal having low hardness and high ductility in the metal base layer 21 rather than the metal cover layer 23, it is possible to mitigate the stress readily and increase the mechanical strength. Therefore, the metal serving as the main component of the metal cover layer 23 is preferably different from the metal serving as the main component of the metal base layer 21.

The metal cover layer 23 includes a glass component. No particular limitation is imposed on the metal serving as the main component of the metal cover layer 23. The metal serving as the main component of the metal cover layer 23 preferably improves adhesion to the plating layer 24. Examples of the metal serving as the main component of the metal cover layer 23 include, for example: base metals, such as copper (Cu), nickel (Ni), titanium (Ti), Sn (tin), and the like, and alloys including these; and noble metals, such as platinum (Pt), palladium (Pd), silver (Ag), gold (Au), and the like, and alloys including these. These may be used alone or in combination. Of these, the metal cover layer 23 preferably includes copper or nickel as the main component, and more preferably includes copper as the main component.

The glass component included in the metal cover layer 23 is, for example, the same as the glass component included in the metal base layer 21. The metal cover layer 23 may also include particles of a ceramic, such as, for example, a co-existent material for controlling firing properties of the external electrodes 20A and 20B. The particles of the ceramic included in the metal cover layer 23 are, for example, the same as the particles of the ceramic included in the metal base layer 21.

When the metal cover layer 23 includes a glass component, the amount of the glass component is preferably 25% by mass or less, more preferably 15% by mass or less, relative to the total mass of the metal cover layer 23.

No particular limitation is imposed on the average thickness of the metal cover layer 23, and the average thickness of the metal cover layer 23 is preferably 5 μm or more and 100 μm or less, more preferably 10 μm or more and 50 μm or less, and further preferably 20 μm or more and 40 μm or less.

No particular limitation is imposed on the ratio (N/M) of the average thickness N of the insulating layer 22 to the total M of the average thickness of the metal base layer 21 and the average thickness of the metal cover layer 23. The ratio (N/M) is preferably 0.0005 or more and 1 or less, and more preferably 0.01 or more and 0.1 or less. When the ratio (N/M) is 0.0005 or more, the hardness of the external electrodes 20A and 20B can be increased. This can increase the mechanical strength against the stress caused by the deflection of the board and the change in temperature, thereby more successfully suppressing the formation of cracks during mounting on a circuit board and during use. When the ratio (N/M) is 1 or less, the flexibility of the external electrodes 20A and 20B is not impaired, which can more effectively suppress the formation of cracks during mounting on a circuit board and during use.

### <Plating Layer 24>

The plating layer 24 includes a first plating layer 24a and a second plating layer 24b. This can improve mountability with solder, such as, for example, prevention of erosion by solder during mounting on a circuit board, and improvement in wettability of solder.

No particular limitation is imposed on the compositions of the first plating layer 24a and the second plating layer 24b, and the compositions of the first plating layer 24a and the second plating layer 24b may be appropriately selected in accordance with the intended purpose. From the viewpoints of improvement in reliability and mountability with solder of the multilayer ceramic capacitor 100, the compositions of the first plating layer 24a and the second plating layer 24b are, for example, a metal, such as copper (Cu), nickel (Ni), aluminum (Al), zinc (Zn), tin (Sn), or the like, or an alloy of two or more of these. A film of a conductive resin, such as an epoxy resin, a urethane resin, or the like, may be formed on the surface of the plating layer 24. Of these, the first plating layer 24a is preferably a plating layer of Ni, and the second plating layer 24b is preferably a plating layer of Sn. The plating layer 24 may include three or more layers.

No particular limitation is imposed on the average thickness of the plating layer 24, and the total average thickness of the total of the thicknesses of the first plating layer 24a and the second plating layer 24b is preferably 1 μm or more and 30 μm or less, more preferably 5 μm or more and 15 μm or less, and further preferably 10 μm or more and 15 μm or less.

The amount of each metal in the metal base layer 21, the metal cover layer 23, and the plating layer 24 can be confirmed by performing elemental analysis of each layer using various measuring devices, and calculating the percentage by number of atoms of each component relative to all the detected elements. Examples of the measuring devices for elemental analysis include those exemplified for the measurement of the amount of each metal in the internal electrodes 12.

The amounts of the components other than the metal in each of the metal base layer 21, the metal cover layer 23, and the plating layer 24 can be calculated from the amounts of raw materials used when producing each layer.

For the evaluation of the average thickness of each of the metal base layer 21, the insulating layer 22, the metal cover layer 23, and the plating layer 24, a sample is prepared in which a widthwise cross section of the measurement target layer is exposed in the measurement region. The exposure of the cross section is performed by polishing or cutting. For example, as illustrated in FIG. 2, the multilayer ceramic capacitor 100 is polished or cut up to the center along the Y axis to prepare a sample including an exposed XZ plane in which the metal base layer 21, the insulating layer 22, the metal cover layer 23, and the plating layer 24 are laminated. Alternatively, for example, as illustrated in FIG. 3, the multilayer ceramic capacitor 100 is polished or cut up to the center along the Z axis to prepare a sample including an exposed XY plane in which the metal base layer 21, the insulating layer 22, the metal cover layer 23, and the plating layer 24 are laminated. In the exposed cross section, three points are randomly selected from the measurement target layer (i.e., each of the metal base layer 21, the insulating layer 22, the metal cover layer 23, and the plating layer 24) and are measured for the thickness. The average of the measured thicknesses is calculated. This average is used as the average thickness of each of the metal base layer 21, the insulating layer 22, the metal cover layer 23, and the plating layer 24 in the multilayer ceramic capacitor 100. The thickness of each of the metal base layer 21, the insulating layer 22, the metal cover layer 23, and the plating layer 24 can be measured, for example, by a microscope.

The multilayer ceramic electronic component according to the first embodiment can be successfully produced by the production method of the multilayer ceramic electronic component according to the embodiment described below. The multilayer ceramic capacitor 100 according to the first embodiment is especially effective at a low rating and a low capacity.

### (Second Embodiment)

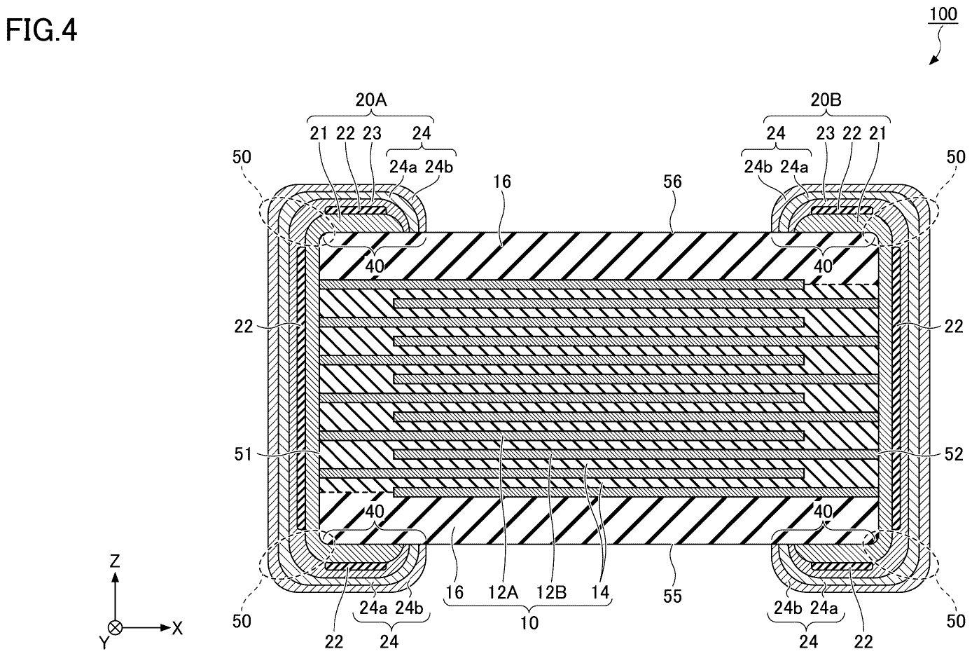

FIG. 4 is a cross-sectional diagram illustrating an example of a multilayer ceramic capacitor according to a second embodiment of the present disclosure. In the multilayer ceramic capacitor 100 according to the second embodiment, the insulating layer 22 is disposed over the metal base layers 21 that are over the end surfaces 51 and 52 of the body 10 and over the four surfaces of the body 10, i.e., the bottom surface 55, the top surface 56, and the pair of side surfaces 53 and 54, and both ends of the insulating layer 22 are in contact with the metal cover layers 23 and are not disposed at the corners 50 of the body 10. The ends of the metal cover layers 23 disposed over the four surfaces of the body 10 are in contact with the body 10. The multilayer ceramic capacitor 100 according to the second embodiment is different from the multilayer ceramic capacitor 100 according to the first embodiment in that the insulating layer 22 is disposed not only over the metal base layers 21 that are over the four surfaces of the body 10 but also over the metal base layers 21 that are over the end surfaces 51 and 52 of the body 10. Here, the differences of the multilayer ceramic capacitor 100 according to the second embodiment from the multilayer ceramic capacitor 100 according to the first embodiment will be described below.

The insulating layer 22 may be formed continuously or discontinuously. In a cross-sectional view of the multilayer ceramic capacitor 100 in the first direction, the coverage of the insulating layer 22 on each of the metal base layers 21 is preferably 70% or more, more preferably 80% or more, and further preferably 90% or more. The closer the coverage on the metal base layer 21 is to 100%, the better the continuation of the insulating layer 22. When the insulating layer 22 is formed continuously, the coverage on the metal base layer 21 is 100%.

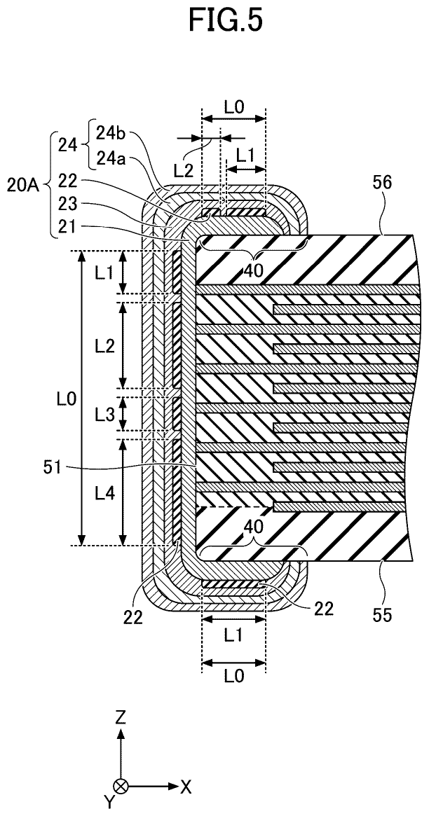

FIG. 5 is a schematic explanatory diagram of a coverage of the insulating layer on the metal base layer. In the insulating layer 22 disposed over the metal base layer 21 that is over the end surface 51 of the body 10, the length of a straight line in the second direction (Z-axis direction) from the end of the insulating layer 22 closest to the top surface 56 to the end of the insulating layer 22 closest to the bottom surface 55 is defined as a maximum straight-line length L0 of the insulating layer 22 disposed over the metal base layer 21 that is over the end surface 51 of the body 10. When the insulating layer 22 is discontinuous, maximum straight-line lengths L1, L2, L3, L4, . . . , and Ln of the insulating layers 22 in the second direction are measured and summed. ΣLn/L0, i.e., the ratio of the portions of the insulating layers 22 to L0, is defined as the coverage of the insulating layer 22 on the metal base layer 21 that is over the end surface 51. Although not illustrated, the coverage of the insulating layer 22 on the metal base layer 21 over the end surface 52 of the body 10 can be calculated in the same manner.

Similarly, as illustrated in FIG. 5, for the coverage of the insulating layer 22 disposed over the metal base layer 21 that is over each of the top surface 56 and the bottom surface 55 of the body, the length of a straight line in the first direction (X-axis direction) from the end of the insulating layer 22 closest to the end surface 51 to the end of the insulating layer 22 farthest from the end surface 51, i.e., the end of the insulating layer 22 closet to the center of the body 10, is defined as a maximum straight-line length L0 of the insulating layer 22 disposed over the metal base layer 21 over the top surface 56 or the bottom surface 55 of the body 10. When the insulating layer 22 is discontinuous, L1, L2, L3, L4, . . . , and Ln, each of which is the maximum straight-line length of each of the insulating layers 22 in the first direction, are measured and summed. Σ Ln/L0, i.e., the ratio of the portions of the insulating layers 22 to L0, is defined as the coverage of the insulating layer 22 on the metal base layer 21 over the top surface 56 or the bottom surface 55. In FIG. 5, the coverage of the insulating layer 22 on the metal base layer 21 over the bottom surface 55 is 100%. Although not illustrated, the coverage of the insulating layer 22 on the metal base layer 21 over the top surface 56 or the bottom surface 55 in the external electrode 20B can be calculated in the same manner.

The above description has been made using the XZ plane as the cross-sectional view of the multilayer ceramic capacitor 100 in the first direction. However, the coverage of the insulating layer 22 on the metal base layer 21 over the end surface 51 of the body 10, the coverage of the insulating layer 22 on the metal base layer 21 over the end surface 52 of the body 10, and the coverage of the insulating layer 22 on the metal base layer 21 over each of the top surface 56 and the bottom surface 55 in the external electrodes 20A and 20B can be calculated similarly in the cross-sectional view of the XY plane.

The stress caused by the change in temperature is applied not only to the end portions 40 but also to the multilayer ceramic capacitor 100 at random. Therefore, the multilayer ceramic capacitor 100 according to the second embodiment, in which the insulating layer 22 is disposed not only over the metal base layers 21 over the four surfaces of the body 10 but also over the metal base layers 21 over the end surfaces 51 and 52 of the body 10, readily mitigates the stress applied from various directions. Also, when the insulating layer 22 is disposed not only over the metal base layers 21 over the four surfaces of the body 10 but also over the metal base layers 21 over the end surfaces 51 and 52, it is possible to suppress transmission of the stress caused by the deflection of the board during mounting on a circuit board toward the end surfaces 51 and 52 of the body 10. Further, the insulating layer 22 disposed over the end surfaces of the body 10 can protect the connection between the internal electrodes 12A and 12B and the metal base layers 21.

### (Third Embodiment)

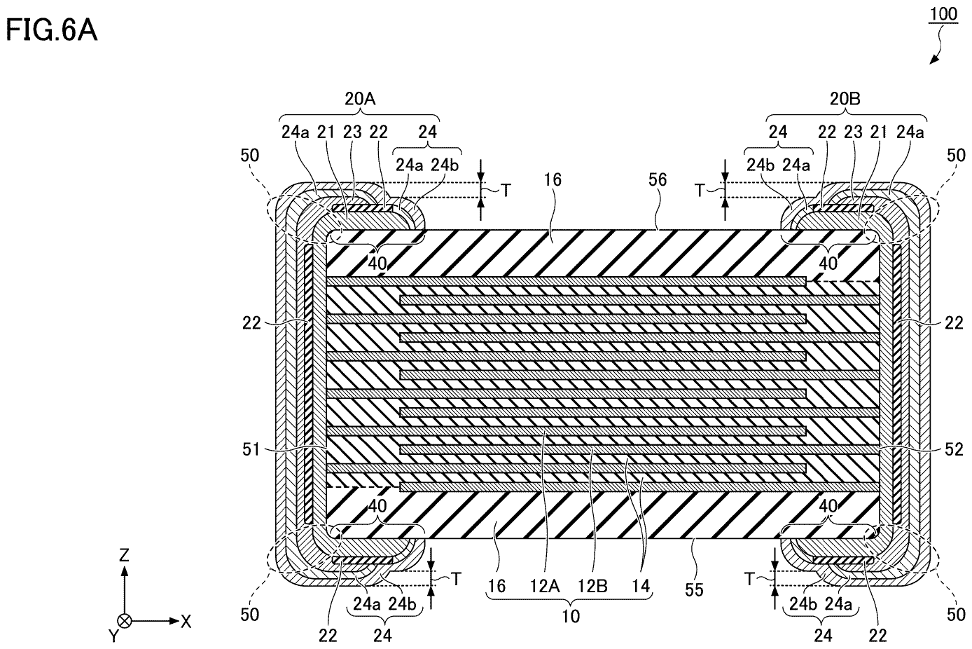

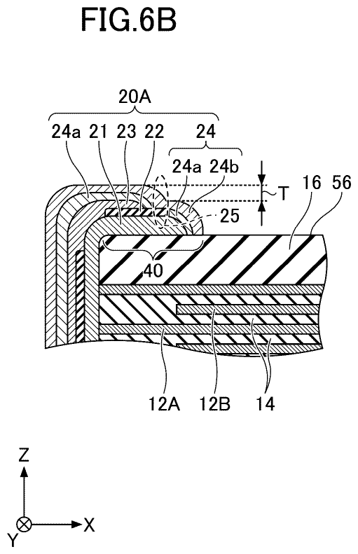

FIG. 6A is a schematic cross-sectional diagram illustrating an example of a multilayer ceramic capacitor according to a third embodiment of the present disclosure. FIG. 6B is an enlarged diagram of an end portion in FIG. 6A. In the multilayer ceramic capacitor 100 according to the third embodiment, the insulating layer 22 is disposed over the metal base layers 21 that are over the end surfaces 51 and 52 of the body 10 and over the four surfaces of the body 10, i.e., the bottom surface 55, the top surface 56, and the pair of side surfaces 53 and 54, the insulating layer 22 disposed over the four surfaces of the body 10 includes a first end and a second end, the first end is located closer to any one of the end surfaces 51 and 52 than is the second end, and the second end is exposed from the metal cover layer 23. The multilayer ceramic capacitor 100 according to the third embodiment is different from the multilayer ceramic capacitor 100 according to the second embodiment in that the second end of the insulating layer 22 is exposed from the metal cover layer 23. Here, the differences of the multilayer ceramic capacitor 100 according to the third embodiment from the multilayer ceramic capacitor 100 according to the second embodiment will be described below.

In the multilayer ceramic capacitor 100 according to the third embodiment, the second end of the insulating layer 22 is exposed from the metal cover layer 23, and thus the second end of the insulating layer 22 is preferably covered by the plating layer 24. In this configuration, a step T is formed between: the plating layer 24 covering the first end of the insulating layer 22; and the plating layer 24 covering the second end of the insulating layer 22 and the end of the metal base layer 21. Thus, during mounting of the multilayer ceramic capacitor 100 on a circuit board, solder enters between the circuit board and the step T, thereby suppressing solder wicking in the +Z-axis direction, i.e., the second direction. Also, it is known that stress caused during mounting of the multilayer ceramic capacitor 100 on a circuit board is applied to the end portions 40 of the external electrodes 20A and 20B. In the multilayer ceramic capacitor 100 according to the third embodiment, the first plating layer 24a disposed over the four surfaces of the body 10 includes an opening 25 in the insulating layer 22. That is, the first plating layer 24a disposed over the four surfaces of the body 10 is discontinuous. Thus, in each of the end portions 40, the stress is dispersed to two locations, i.e., the end of the metal base layer 21 and the end of the metal cover layer 23. As a result, the stress is mitigated during mounting of the multilayer ceramic capacitor 100 on a circuit board, thereby increasing the mechanical strength against cracks formed due to tensile stress and deflection occurring in the formation of the plating layer 24.

### (Fourth Embodiment)

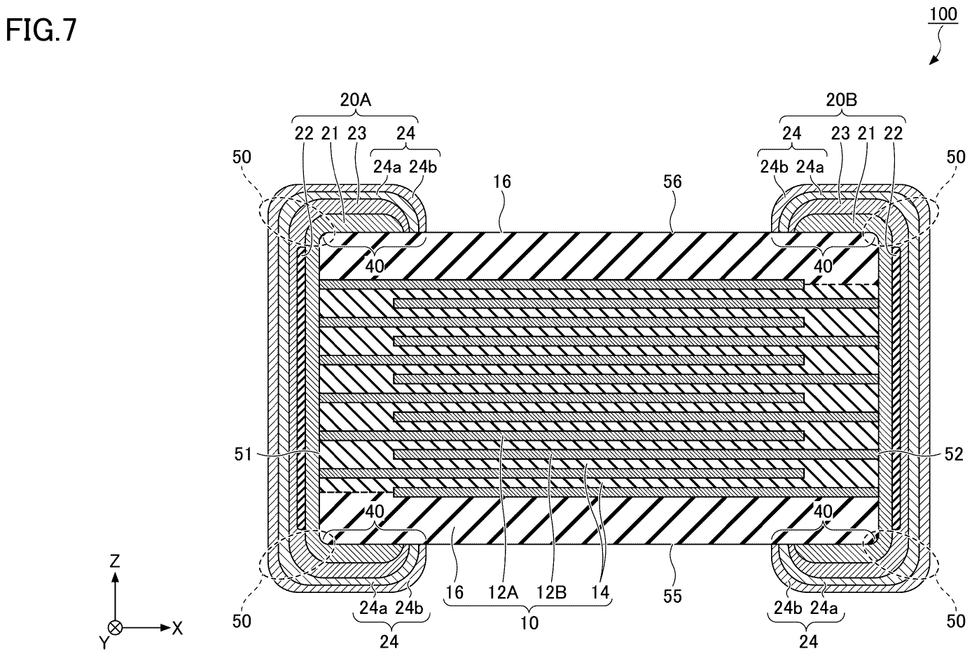

FIG. 7 is a schematic cross-sectional diagram illustrating an example of a multilayer ceramic capacitor according to a fourth embodiment of the present disclosure. In the multilayer ceramic capacitor 100 according to the fourth embodiment, the insulating layer 22 is disposed over the metal base layers 21 that are over the end surfaces 51 and 52 of the body 10, the insulating layer 22 is not disposed over the metal base layers 21 that are over the four surfaces of the body 10, i.e., the bottom surface 55, the top surface 56, and the pair of side surfaces 53 and 54, and the ends of the metal cover layer 23 disposed over the four surfaces of the body 10 are in contact with the body 10. The multilayer ceramic capacitor 100 according to the fourth embodiment is different from the multilayer ceramic capacitor 100 according to the first embodiment in that the insulating layer 22 is not disposed over the metal base layers 21 that are over the four surfaces of the body 10, and is only disposed over the metal base layers 21 that are over the end surfaces 51 and 52 of the body 10.

In the multilayer ceramic capacitor 100 according to the fourth embodiment, the insulating layer 22 is not disposed over the metal base layers 21 that are over the four surfaces of the body 10, and thus the resistance of the external electrodes 20A and 20B is low. Also, similar to the multilayer ceramic capacitor 100 according to the second embodiment, the insulating layer 22 is disposed over the metal base layers 21 that are over the end surfaces 51 and 52 of the body 10, and thus it is possible to successfully suppress transmission of the stress caused by the deflection of a board during mounting on a circuit board toward the end surfaces 51 and 52 of the body 10, thereby suppressing the formation of cracks in the end portions 40. Therefore, the multilayer ceramic capacitor 100 according to the fourth embodiment is effective at a high rating and a high capacity.

### (Fifth Embodiment)

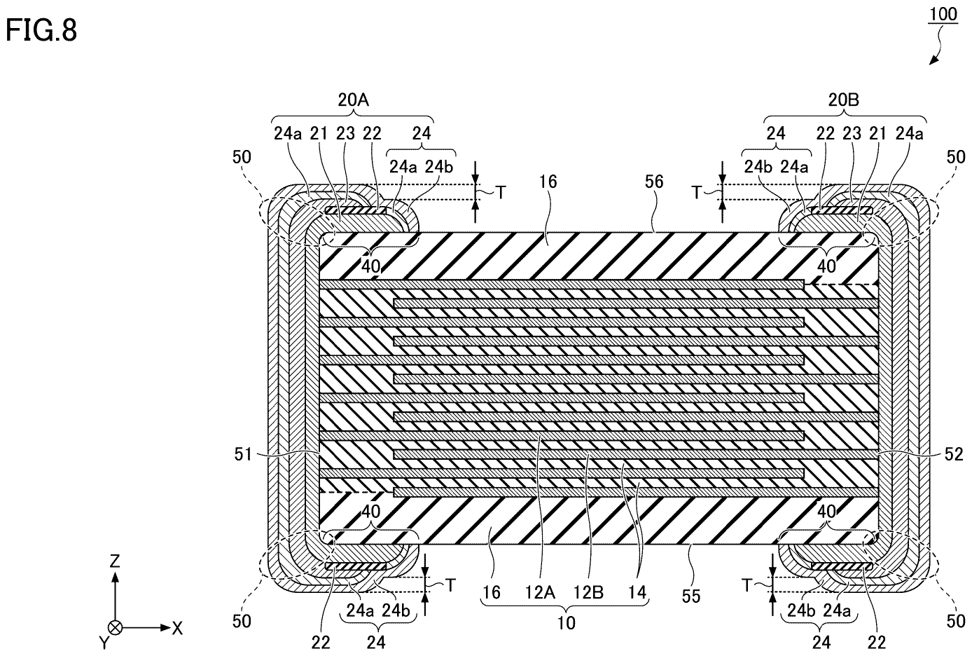

FIG. 8 is a schematic cross-sectional diagram illustrating an example of a multilayer ceramic capacitor according to a fifth embodiment of the present disclosure. In the multilayer ceramic capacitor 100 according to the fifth embodiment, the insulating layer 22 is disposed over the metal base layers 21 that are over the four surfaces of the body 10, i.e., the bottom surface 55, the top surface 56, and the pair of side surfaces 53 and 54, the insulating layer 22 is not disposed over the metal base layers 21 that are over the end surfaces 51 and 52 of the body 10, the ends of the metal cover layer 23 disposed over the four surfaces of the body 11 are in contact with the insulating layer 22, the insulating layer 22 disposed over the four surfaces of the body 10 includes a first end and a second end, the first end is located closer to any one of the end surfaces 51 and 52 than is the second end, and the second end is exposed from the metal cover layer 23. The multilayer ceramic capacitor 100 according to the fifth embodiment is different from the multilayer ceramic capacitor 100 according to the first embodiment in that the second end of the insulating layer 22 is exposed from the metal cover layer 23.

Similar to the multilayer ceramic capacitor 100 according to the first embodiment, the multilayer ceramic capacitor 100 according to the fifth embodiment can successfully suppress the formation of cracks during mounting on a circuit board. Also, similar to the multilayer ceramic capacitor 100 according to the third embodiment, during mounting of the multilayer ceramic capacitor 100 on a circuit board, solder enters between the circuit board and the step T, thereby suppressing solder wicking in the +Z-axis direction, i.e., the second direction. Therefore, the multilayer ceramic capacitor 100 according to the fifth embodiment is effective at a high rating and a high capacity.

### (Comparative Embodiment)

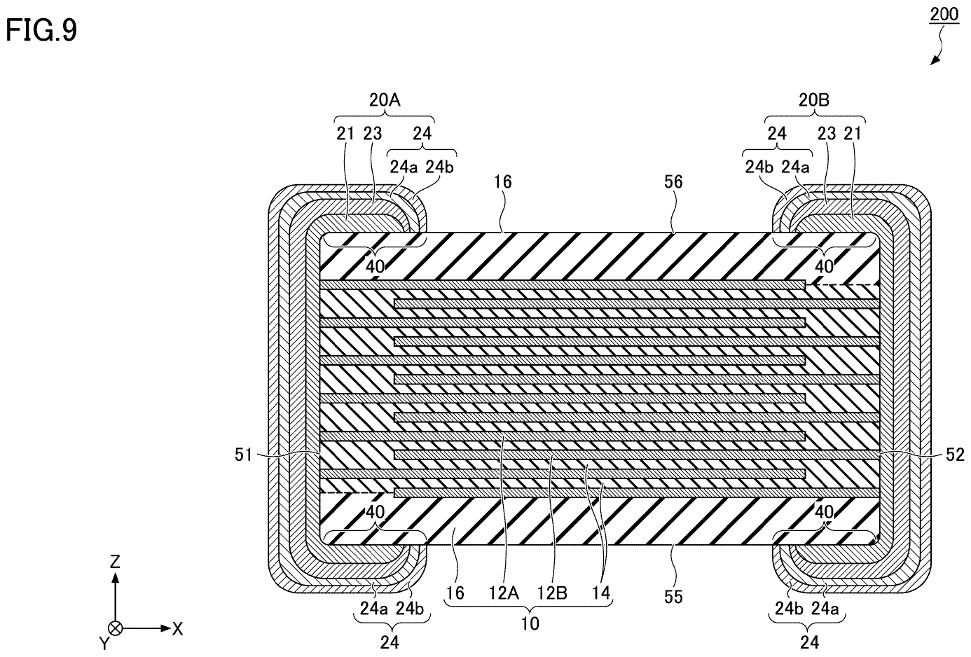

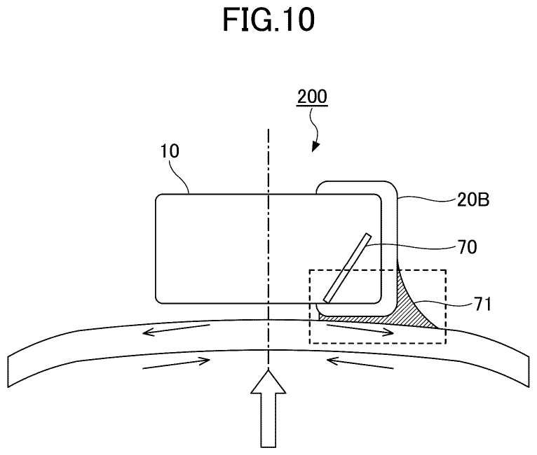

FIG. 9 is a schematic cross-sectional diagram illustrating an example of a multilayer ceramic capacitor according to a conventional comparative embodiment. FIG. 10 is a schematic explanatory diagram illustrating mounting of the multilayer ceramic capacitor according to the conventional comparative embodiment on a circuit board. The multilayer ceramic capacitor 200 according to the comparative embodiment is different from the multilayer ceramic capacitors 100 according to the first to fifth embodiments in that the multilayer ceramic capacitor 200 does not include the insulating layer 22.

Since the multilayer ceramic capacitor 200 according to the comparative embodiment does not include the glass-including insulating layer 22 over the end surfaces 51 and 52 of the body 10, it is not possible to suppress cracks formed in an environment in which the temperature repeatedly changes between a high temperature and a low temperature. Also, when the multilayer ceramic capacitor 200 according to the comparative embodiment is to be mounted on a board, the external electrodes over both end surfaces of the multilayer ceramic capacitor 200 or the external electrode over any side surface of the multilayer ceramic capacitor 200, here, the external electrode 20B, are/is mounted on the board by solder 71. In this case, when deflection of the board occurs, stress caused by the deflection is transmitted to the external electrode 20B over the side surface of the multilayer ceramic capacitor 200. This forms stress in a region enclosed by a broken line. As a result, a crack 70 is formed in the body 10 of the multilayer ceramic capacitor 200.

### Production Method of Multilayer Ceramic Capacitor

A production method of the multilayer ceramic electronic component according to the embodiment of the present disclosure includes: a body providing step; a metal base layer forming step; an insulating layer forming step; and a metal cover layer forming step. Preferably, the production method of the multilayer ceramic electronic component of the present disclosure further includes a plating layer forming step. If necessary, the production method of the multilayer ceramic electronic component of the present disclosure may further include other steps.

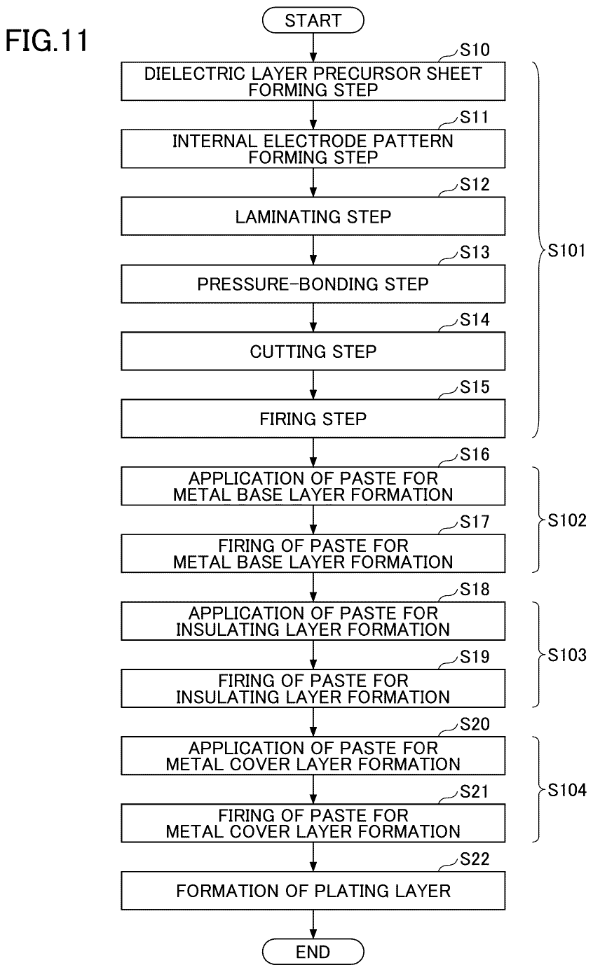

FIG. 11 is a flowchart of the production method of the multilayer ceramic capacitor 100 according to an embodiment of the present disclosure.

### (Step S101: Body Providing Step)

In the body providing step (step S101), the body 10 including the plurality of internal electrodes 12A and 12B and the plurality of dielectric layers 14 laminated in an alternating manner, the pair of end surfaces 51 and 52 from which the laminated internal electrodes 12A and 12B are respectively exposed in an alternating manner and which face each other in the first direction, the four surfaces connected to the end surfaces 51 and 52, and the corners 50 between the end surfaces 51 and 52 and the four surfaces connected to the end surfaces 51 and 52, is provided.

The body providing step may include a dielectric layer precursor sheet forming step, an internal electrode pattern forming step, a laminating step, a pressure-bonding step, a cutting step, and a firing step.

### <Step S10: Dielectric Layer Precursor Sheet Forming Step>

In the dielectric layer precursor sheet forming step (step S10), for example, a dielectric material is prepared by adding various additive compounds (e.g., a firing aid) to a raw material powder of ceramic. The raw material powder of ceramic, i.e., the dielectric material, includes, for example, a material that can yield ceramic including a compound having a perovskite structure represented by the general formula ABO_{3-α}(0≤α≤1). For example, barium titanate (BaTiO₃) is a tetragonal compound having a perovskite structure, and exhibits a high relative dielectric constant. Barium titanate can be typically obtained through reaction between a titanium raw material, such as titanium dioxide or the like, and a barium raw material, such as barium carbonate or the like.

Various methods have been known as a synthesis method of the raw material powder of ceramic, such as a solid-phase method, a sol-gel method, a hydrothermal method, and the like. In the embodiment of the present disclosure, any of these methods can be employed.

The average particle diameter of the raw material powder of ceramic is preferably 10 nm to 500 nm from the viewpoint of thinning the dielectric layer 14.

A predetermined additive or additive compound can be added to the raw material powder of ceramic, i.e., the dielectric material, in accordance with the intended purpose. Examples of the additive or additive compound include, for example: one or more elements selected from the group consisting of zirconium (Zr), niobium (Nb), molybdenum (Mo), tantalum (Ta), tungsten (W), magnesium (Mg), manganese (Mn), vanadium (V), and chromium (Cr); oxides including one or more rare earth elements selected from the group consisting of scandium (Sc), yttrium (Y), cerium (Ce), neodymium (Nd), samarium (Sm), europium (Eu), gadolinium (Gd), terbium (Tb), dysprosium (Dy), holmium (Ho), erbium (Er), thulium (Tm), and ytterbium (Yb); oxides including one or more elements selected from cobalt (Co), nickel (Ni), lithium (Li), boron (B), sodium (Na), potassium (K), and silicon (Si); and glass including one or more elements selected from the group consisting of cobalt (Co), nickel (Ni), lithium (Li), boron (B), sodium (Na), potassium (K), and silicon (Si). These may be used alone or in combination. Of these, silicon dioxide (SiO₂), i.e., an oxide of silicon (Si), suitably functions as a firing aid.

The preparation method of the dielectric material is, for example, a method of preparing the dielectric material by wet mixing a compound including the additive and the additive compound with the raw material powder of ceramic, if necessary, followed by drying and pulverizing. Also, after the drying and pulverizing, the raw material powder may be subjected to a pulverizing treatment to adjust the particle diameter, or further to a classification treatment in combination to adjust the particle diameter.

Next, an organic binder, an organic solvent, a plasticizer, and the like are added to the prepared dielectric material, followed by wet mixing to form a slurry. No particular limitation is imposed on the organic binder, and the organic binder may be a publicly known resin, such as a polyvinyl butyral (PVB) resin or the like. No particular limitation is imposed on the organic solvent, and examples of the organic solvent include ethanol, toluene, and the like.

No particular limitation is imposed on the preparation method of the slurry, and the preparation method of the slurry is, for example, a method of wet mixing a dielectric material, an organic binder, an organic solvent, and a plasticizer. Alternatively, when the raw material powder of ceramic or the like is mixed for the preparation of the dielectric material, an organic binder or the like may be added, followed by wet mixing.

Next, the slurry is coated on a substrate. For example, the obtained slurry can be coated on the substrate by means of a die coater or a doctor blade. Subsequently, the substrate, on which the slurry is coated, is dried to form a dielectric layer precursor sheet. One example of the dielectric layer precursor sheet is a ceramic precursor sheet. The thickness of the dielectric layer precursor sheet can be appropriately selected in accordance with the intended average thickness of the dielectric layers 14.

No particular limitation is imposed on the substrate, and the substrate is preferably a material from which the dielectric layer precursor sheet can be peeled. The substrate is, for example, a polyethylene terephthalate (PET) film.

### <Step S11: Internal Electrode Pattern Forming Step>

In the internal electrode pattern forming step (step S11), a metal pattern to be the internal electrodes 12 is formed on the dielectric layer precursor sheet. Specifically, a conductor paste for internal electrode formation including an organic binder is printed on the dielectric layer precursor sheet, for example, through gravure printing. Thus, a plurality of metal patterns corresponding to the internal electrodes 12 are formed on the dielectric layer precursor sheet to be spaced apart from each other.

The conductor paste may include: a base metal, such as Ni (nickel), Cu (copper), Sn (tin), or the like, or an alloy including the base metal; a metal powder serving as a main component of, for example, a noble metal, such as platinum (Pt), palladium (Pd), silver (Ag), gold (Au), or the like, or an alloy including the noble metal; a binder; and an organic solvent. Also, the conductor paste may include, as a co-existent material, ceramic particles of, for example, a compound having a perovskite structure represented by the general formula ABO_{3-α}(0≤α≤1).

The conductive paste can be prepared by kneading a metal to be a main component and, if necessary, other components, such as a co-existent material and the like.

The conductor paste can be printed by a printing method, such as screen printing, gravure printing, or the like. The forming method of the internal electrode pattern in the internal electrode pattern forming step (step S11) is not limited to the printing method, and may be a plating method, a vacuum deposition method, a sputtering method, or a chemical vapor deposition (CVD) method. Thus, the internal electrode pattern for the internal electrodes 12A or the internal electrode pattern for the internal electrodes 12B is formed on the surface of the dielectric layer precursor sheet.

Also, it is possible to obtain a dielectric pattern paste for a reverse pattern layer by adding an organic binder, such as an ethyl cellulose-based binder or the like, and an organic solvent, such as a terpineol-based organic solvent or the like, to the dielectric material obtained in the dielectric layer precursor sheet forming step (step S10), followed by kneading using a roll mill. Then, a dielectric pattern may be placed by placing the dielectric pattern paste on a peripheral region of the dielectric layer precursor sheet where no first internal electrode pattern and no second internal electrode pattern are formed, to fill the gap from the first internal electrode pattern and the second internal electrode pattern. The dielectric layer precursor sheet on which the internal electrode pattern and the dielectric pattern are formed is referred to as a lamination unit.

### <Step S12: Laminating Step>

In the laminating step (step S12), a laminate is formed in which two or more dielectric layer precursor layers, on which the internal electrode pattern is formed, are laminated along the second direction.

While peeling the substrate from the dielectric layer precursor sheet, the dielectric layer precursor sheet on which the internal electrode pattern for the internal electrodes 12A and the dielectric patten are formed, and the dielectric layer precursor sheet on which the internal electrode pattern for the internal electrodes 12B and the dielectric pattern are formed, are laminated in this order. Here, it is preferable to laminate the lamination units such that the internal electrodes 12 and the dielectric layers 14 alternate and such that the edges of the internal electrode layers 12 are exposed to the end surfaces 51 and 52 of the dielectric layers 14 on alternate sides in the lengthwise direction and drawn to alternate ones of a pair of the metal base layers 21 having different polarities.

No particular limitation is imposed on the number of lamination units to be laminated, and the number of lamination units to be laminated may be appropriately selected in accordance with the intended purpose. For example, the number of lamination units to be laminated can be 100 layers to 500 layers.

Also, a dielectric cover layer precursor layer may be further laminated on the top and bottom surfaces of the laminate of the dielectric layer precursor layer. No particular limitation is imposed on the number of the dielectric cover layer precursor layers to be laminated, and the number of the dielectric cover layer precursor layers to be laminated may be approximately selected in accordance with the intended purpose. The number of the dielectric cover layer precursor layers to be laminated may be, for example, two layers to ten layers. The material of the dielectric cover layer precursor layer may be the same as that of the dielectric layer precursor layer, and the additive and additive compound to be added to the raw material powder of ceramic may be different.

### <Step S13: Pressure-Bonding Step>

In the pressure-bonding step (step S13), the laminate formed in the laminating step (step S12) is pressurized for pressure bonding a plurality of dielectric layer precursors. In the laminating step (step S12), the laminate obtained in the above-described manner, preferably the laminate of the dielectric layer precursor layer in which the top and bottom surfaces are covered by the dielectric cover layer 16, is thermally bonded to form the laminate. For pressure bonding, for example, a hydrostatic press can be used.

### <Step S14: Cutting Step>

In the cutting step (step S14), the laminate obtained in the pressure-bonding step (step S13) is cut in the lamination direction into individual pieces. This provides a plurality of laminates including: the alternately laminated first and second internal electrode patterns and dielectric layer precursor sheets including ceramic as a main component; the pair of end surfaces 51 and 52 from which the laminated first and second internal electrode patterns are respectively exposed in an alternating manner and which face each other in the first direction; the four surfaces connected to the end surfaces 51 and 52; and the corners 50 between the end surfaces 51 and 52 and the four surfaces connected to the end surfaces 51 and 52.

No particular limitation is imposed on the cutting method of the laminate, and the cutting method of the laminate is, for example, an existing method, such as a method using a cutting blade, dicing using a dicer, laser cutting, or the like.

No particular limitation is imposed on the size of the pieces into which the laminate is cut, and the size of the pieces may be appropriately selected in accordance with a desired size of the multilayer ceramic capacitor 100.

In the laminate obtained in the cutting step (step S14), the first internal electrode patterns are exposed from the end surface 51, and the second internal electrode patterns are exposed from the end surface 52. After cutting, the laminate may be polished by a method, such as barrel polishing or the like. Thus, the corners of the laminate are rounded.

### <Step S15: Firing Step>

In the firing step (step S15), the laminate is fired. The firing step (step S15) may be firing only the laminate in accordance with a combination of the main component metal in the conductor paste used in the internal electrode pattern forming step (step S11) and the main component metal of the metal paste used in the metal base layer forming step (step S102) and the metal cover layer forming step (step S104). Alternatively, the firing step (step S15) may be firing both the laminate and the metal base layer precursor and/or the metal cover layer precursor after the metal base layer forming step (step S102) or the metal cover layer forming step (step S104).

No particular limitation is imposed on the temperature at which the laminate is fired. Preferably, the laminate is subjected to a debinding treatment in a nitrogen gas atmosphere of 250 degrees Celsius (°C) to 500 °C, and then is fired in a reducing atmosphere at 1,300 °C to 1,400 °C for about one hour. Thus, the laminate and the particles of the first and second internal electrode patterns are fired.

The above procedure produces the body 10 including: the alternately laminated internal electrodes 12A and 12B and dielectric layers 14 including ceramic as a main component; the pair of end surfaces 51 and 52 from which the laminated internal electrodes 12A and 12B are respectively exposed in an alternating manner and which face each other in the first direction; the four surfaces connected to the end surfaces 51 and 52; and the corners 50 between the end surfaces 51 and 52 and the four surfaces connected to the end surfaces 51 and 52.

### (Step S102: Metal Base Layer Forming Step)

In the metal base layer forming step (step S102), the pair of metal base layers 21 are formed to extend from the pair of end surfaces 51 and 52 to a portion of the four surfaces, i.e., the bottom surface 55, the top surface 56, and the pair of side surfaces 53 and 54.

The metal base layer forming step (step S102) preferably includes applying a paste for metal base layer formation to the portion of the four surfaces from the pair of end surfaces 51 and 52 (step S16) and firing the paste for metal base layer formation (step S17).

### <Step S16: Application of Paste for Metal Base Layer Formation>

In the application of the paste for metal base layer formation (step S16), the paste for metal base layer formation is applied to the portion of the four surfaces from the pair of end surfaces 51 and 52 of the body 10.

The paste for metal base layer formation is, for example, applied from the end surfaces 51 and 52 of the body 10 through dipping.

No particular limitation is imposed on the main component of the paste for metal base layer formation, and the main component of the paste for metal base layer formation may be appropriately selected in accordance with the intended purpose from components that are typically used in the metal base layer of the multilayer ceramic capacitor. Examples of the main component of the paste for metal base layer formation include metals, such as copper (Cu), nickel (Ni), aluminum (Al), zinc (Zn), and the like, and alloys of two or more of these metals (e.g. an alloy of copper and nickel).

The thickness of the metal base layer 21 can be adjusted by adjusting the applied amount of the paste for metal base layer formation. Also, the thickness of the metal base layer 21 can be adjusted by adjusting the number of times application of the paste for metal base layer formation is performed. The number of times application of the paste for metal base layer formation is performed may be one or more.

### <Step S17: Firing of Paste for Metal Base Layer Formation>

In the firing of the paste for metal base layer formation (step S17), the paste for metal base layer formation applied in the application of the paste for metal base layer formation (step S16) is fired.

No particular limitation is imposed on the firing temperature of the paste for metal base layer formation, and the firing temperature of the paste for metal base layer formation may be appropriately selected in accordance with the composition of the paste for metal base layer formation.

When the main component of the paste for metal base layer formation is the same as the main component of the conductive paste used in the internal electrode pattern forming step (step S11), the firing temperature can be the same as that in the firing step (step S15). Alternatively, the firing step (step S15) may be omitted, and the paste for metal base layer formation may be fired simultaneously with the firing of the laminate. The firing conditions in this case are the same as those in the firing step (step S15).

### (Step S103: Insulating Layer Forming Step)

In the insulating layer forming step (step S103), the glass-including insulating layer 22 is formed over the metal base layers 21 that are over the end surfaces 51 and 52 of the body 10, the four surfaces of the body 10, or both the end surfaces 51 and 52 of the body 10 and the four surfaces of the body 10.

The insulating layer forming step (step S103) preferably includes applying a paste for insulating layer formation, including glass, to the metal base layers 21 that are over the end surfaces 51 and 52 of the body 10, the four surfaces of the body 10, or both the end surfaces 51 and 52 of the body 10 and the four surfaces of the body 10 (step S18) and firing the paste for insulating layer formation (step S19).

### <Step S18: Application of Paste for Insulating Layer Formation>

In the application of the paste for insulating layer formation (step S18), the paste for insulating layer formation, including glass, is applied to the metal base layers 21 that are over the end surfaces 51 and 52 of the body 10, the four surfaces of the body 10, or both the end surfaces 51 and 52 of the body 10 and the four surfaces of the body 10.

The paste for insulating layer formation is, for example, applied from the end surfaces 51 and 52 of the body 10 through dipping.

The main component of the paste for insulating layer formation is glass. No particular limitation is imposed on the glass, and examples of the glass include oxides of, for example, barium (Ba), strontium (Sr), calcium (Ca), zinc (Zn), aluminum (Al), silicon (Si), and boron (B).

The thickness of the insulating layer 22 can be adjusted by adjusting the applied amount of the paste for insulating layer formation. Also, the thickness of the insulating layer 22 can be adjusted by adjusting the number of times application of the paste for insulating layer formation is performed. The number of times application of the paste for insulating layer formation is performed may be one or more.

### <Step S19: Firing of Paste for Insulating Layer Formation>

In the firing of the paste for insulating layer formation (step S19), the paste for insulating layer formation applied in the application of the paste for insulating layer formation (step S18) is fired.

No particular limitation is imposed on the firing temperature of the paste for insulating layer formation, and the firing temperature of the paste for insulating layer formation may be appropriately selected in accordance with the composition of the paste for insulating layer formation.

### (Step S104: Metal Cover Layer Forming Step)

In the metal cover layer forming step (step S104), the metal cover layer 23 is formed to cover at least a portion of the metal base layers 21 and at least a portion of the insulating layer 22, and to contact the metal base layers 21 at the corners 50 of the body 10.

The metal cover layer forming step (step S104) preferably includes applying the paste for metal cover layer formation to at least a portion of the metal base layers 21 and at least a portion of the insulating layer 22 (step S20), and firing the paste for metal cover layer formation (step S21).

### <Step S20: Application of Paste for Metal Cover Layer Formation>

In the application of the paste for metal cover layer formation (step S20), the paste for metal cover layer formation is applied to at least a portion of the metal base layers 21 and at least a portion of the insulating layer 22.

The paste for metal cover layer formation is, for example, applied from the end surfaces 51 and 52 of the body 10 through dipping.

The paste for metal cover layer formation includes a glass component. No particular limitation is imposed on the main component of the paste for metal cover layer formation, and the main component of the paste for metal cover layer formation may be appropriately selected in accordance with the intended purpose from components that are typically used in the external electrode of the multilayer ceramic capacitor. Examples of the main component of the paste for metal cover layer formation include, for example: base metals, such as copper (Cu), nickel (Ni), tin (Sn), and the like, and alloys including these; and noble metals, such as platinum (Pt), palladium (Pd), silver (Ag), gold (Au), and the like, and alloys including these.

The thickness of the metal cover layer 23 can be adjusted by adjusting the applied amount of the paste for metal cover layer formation. Also, the thickness of the metal cover layer 23 can be adjusted by adjusting the number of times application of the paste for metal cover layer formation is performed. The number of times application of the paste for metal cover layer formation is performed may be one or more.

### <Step S21: Firing of Paste for Metal Cover Layer Formation>

In the firing of the paste for metal cover layer formation (step S21), the paste for metal cover layer formation applied in the application of the paste for metal cover layer formation (step S20) is fired.

No particular limitation is imposed on the firing temperature of the paste for metal cover layer formation, and the firing temperature of the paste for metal cover layer formation may be appropriately selected in accordance with the composition of the paste for metal cover layer formation.

When the main component of the paste for metal cover layer formation is the same as the main component of the conductive paste used in the internal electrode pattern forming step (step S11), the firing temperature can be the same as that in the firing step (step S15). Alternatively, the firing step (step S15) may be omitted, and the paste for metal cover layer formation may be fired simultaneously with the firing of the laminate. The firing conditions in this case are the same as those in the firing step (step S15).

In the firing of the paste for metal cover layer formation (step S21), a small amount of the glass included in the insulating layer 22 is diffused into the metal base layers 21 and the metal cover layer 23. Also, when the paste for insulating layer formation is applied through dipping, the paste for insulating layer formation is thinner at the corners 50 of the body 10 than at the end portions 51 and 52 and the four surfaces of the body 10. Therefore, in the firing of the paste for metal cover layer formation (step S21), the glass component in the paste for insulating layer formation at the corners 50 of the body 10 is diffused into the metal base layers 21 and the metal cover layer 23 and lost, and the metal cover layer 23 is formed to cover at least a portion of the metal base layers 21 and at least a portion of the insulating layer 22, and to contact the metal base layer 21 at the corners 50 of the body 10. For diffusing the glass component at the corners 50 of the body 10 into the metal base layers 21 and the metal cover layer 23, it is preferable to perform two-step firing, i.e., firing of the paste for insulating layer formation (step S19) and firing of the paste for metal cover layer formation (step S21).

The outer periphery defining the metal base layer 21 is preferably formed as a flat surface, but may have a surface with minute irregularities, a surface with a gently curved shape in a predetermined range, or another shape. In such a case, the insulating layer 22 formed over the metal base layer 21 may be discontinuous, but the coverage of the insulating layer 22 on the metal base layer 21 is 70% or more according to the above-described production method.

### (Step S22: Plating Layer Forming Step)

In the plating layer forming step (step S22), the plating layer 24 is formed to cover the metal cover layer 23.

The plating layer 24 is preferably formed through plating. In the plating layer forming step (step S22), for example, it is preferable to perform plating by using a metal, such as copper (Cu), nickel (Ni), aluminum (Al), zinc (Zn), tin (Sn), or the like, or an alloy of two or more of these metals.

By repeatedly performing the plating layer forming step (step S22) a plurality of times, a plurality of plating layers 24, such as the first plating layer 24a, the second plating layer 24b, and the like, are formed.

The above procedure can produce the multilayer ceramic capacitor 100 including: the body 10 including the alternately laminated internal electrodes 12A and 12B and dielectric layers 14 including ceramic as a main component, the pair of end surfaces 51 and 52 from which the laminated internal electrodes 12A and 12B are respectively exposed in an alternating manner and which face each other in the first direction, the four surfaces connected to the end surfaces 51 and 52, i.e., the bottom surface 55, the top surface 56, and the pair of side surfaces 53 and 54, and the corners 50 between the end surfaces 51 and 52 and the four surfaces connected to the end surfaces 51 and 52; the pair of metal base layers 21 extending from the end surfaces 51 and 52 to the portion of the four surfaces; the insulating layer 22 including glass, and disposed over the metal base layers 21 that are over the end surfaces 51 and 52 of the body 10, the four surfaces of the body 10, or both the end surfaces 51 and 52 of the body 10 and the four surfaces of the body 10; and the metal cover layer 23 covering at least the portion of the metal base layers 21 and at least the portion of the insulating layer 22, and contacting the metal base layers 23 at the corners 50 of the body 10.

The above procedure is an example, and the production method of the multilayer ceramic capacitor according to the embodiment of the present disclosure is not limited to the above procedure.

For example, the insulating layer forming step (step S103) can be omitted when producing the multilayer ceramic capacitor 100 of the present disclosure. When the paste for metal base layer formation includes a glass component, the glass component is unevenly distributed in the surface of the metal base layer 21 in the firing of the paste for metal base layer formation (step S17). Therefore, the multilayer ceramic capacitor 100 of the present disclosure can also be produced by a method in which the metal cover layer forming step (step S104) is performed after the firing of the paste for metal base layer formation (step S17). In this case, from the viewpoint of unevenly distributing the glass component in the surface of the metal base layer 21, the firing of the paste for base layer formation (step S17) is preferably performed in a reducing atmosphere at 860 °C or higher for 10 minutes or more, and more preferably at 860 °C or higher and 920 °C or lower for 10 minutes or more and 60 minutes or less.

In another embodiment, the insulating layer forming step (step S103) may be performed such that, in a cross-sectional view in the first direction, the coverage of the insulating layer 22 on the metal base layer 21 is 70% or more, 80% or more, or 90% or more. Also, the insulating layer 22 may be formed continuously or discontinuously. The calculation method of the coverage of the insulating layer 22 on the metal base layer 21 is as described with reference to FIG. 5.

The above procedure is an example, and the production method of the multilayer ceramic capacitor according to the embodiment of the present disclosure is not limited to the above procedure.

### Other Embodiments

Although the embodiments have been described above in detail, the present disclosure is not limited to the specific embodiments, and various modifications and alterations are possible within the scope of claims recited.

For example, although the above embodiments are applied to a multilayer ceramic capacitor having two terminal electrodes, the present disclosure is applicable to a multilayer ceramic capacitor having three or more terminals.

Also, although the multilayer ceramic capacitor has been described as an example of the multilayer ceramic electronic component in the above embodiments, the present disclosure is applicable to various multilayer ceramic electronic components. Examples of such multilayer ceramic electronic components include a chip varistor, a chip thermistor, a multilayer inductor, and the like.

The embodiments of the present disclosure are, for example, as follows.
<1> A multilayer ceramic electronic component, including:
   a body including a plurality of internal electrodes and a plurality of dielectric layers, laminated in an alternating manner, a pair of end surfaces from which the laminated internal electrodes are respectively exposed in an alternating manner and which face each other in a first direction, four surfaces connected to the end surfaces, and
   corners between the end surfaces and the four surfaces connected to the end surfaces, in which the dielectric layers include a ceramic as a main component;
   a pair of metal base layers extending from the end surfaces to a portion of the four surfaces;
   an insulating layer including glass, and disposed over the metal base layers that are over the end surfaces of the body, the four surfaces of the body, or both the end surfaces of the body and the four surfaces of the body; and
   a metal cover layer covering at least a portion of the metal base layers and at least a portion of the insulating layer, and contacting the metal base layers at the corners of the body.
<2> The multilayer ceramic electronic component according to <1>, wherein in a cross-sectional view of the multilayer ceramic electronic component in the first direction, a coverage of the insulating layer on each of the metal base layers is 70% or more.
<3> The multilayer ceramic electronic component according to <1> or <2>, further including:
   a plating layer covering the metal cover layer.
<4> The multilayer ceramic electronic component according to any one of <1>to <3>, wherein
   the insulating layer is disposed over the metal base layers that are over both the end surfaces of the body and the four surfaces of the body, and
   ends of the metal cover layer disposed over the four surfaces of the body are in contact with the body.
<5> The multilayer ceramic electronic component according to any one of <1> to <3>, wherein
   the insulating layer is disposed over the metal base layers that are over both the end surfaces of the body and the four surfaces of the body,
   ends of the metal cover layer disposed over the four surfaces of the body are in contact with the insulating layer, and
   the insulating layer disposed over the four surfaces of the body includes a first end and a second end, the first end is located closer to any one of the end surfaces than is the second end, and the second end is exposed from the metal cover layer.
<6> The multilayer ceramic electronic component according to any one of <1> to <3>, wherein
   the insulating layer is disposed over the metal base layers that are over the end surfaces of the body, and is not disposed over the metal base layers that are over the four surfaces of the body, and
   ends of the metal cover layer disposed over the four surfaces of the body are in contact with the body.
<7> The multilayer ceramic electronic component according to any one of <1> to <3>, wherein
   the insulating layer is disposed over the metal base layers that are over the four surfaces of the body, and is not disposed over the metal base layers that are over the end surfaces of the body, and
   ends of the metal cover layer disposed over the four surfaces of the body are in contact with the body.
<8> The multilayer ceramic electronic component according to any one of <1> to <3>, wherein
   the insulating layer is disposed over the metal base layers that are over the four surfaces of the body, and is not disposed over the metal base layers that are over the end surfaces of the body,
   ends of the metal cover layer disposed over the four surfaces of the body are in contact with the insulating layer, and
   the insulating layer disposed over the four surfaces of the body includes a first end and a second end, the first end is located closer to any one of the end surfaces than is the second end, and the second end is exposed from the metal cover layer.
<9> The multilayer ceramic electronic component according to any one of <1> to <8>, wherein
   the glass includes an oxide of silicon as a main component.
<10> A production method of a multilayer ceramic electronic component, the production method including:
   providing a body including a plurality of internal electrodes and a plurality of dielectric layers, laminated in an alternating manner, a pair of end surfaces from which the laminated internal electrodes are respectively exposed in an alternating manner and which face each other in a first direction, four surfaces connected to the end surfaces, and corners between the end surfaces and the four surfaces connected to the end surfaces, in which the dielectric layers include a ceramic as a main component;
   forming a pair of metal base layers extending from the end surfaces to a portion of the four surfaces;
   forming an insulating layer including glass and disposed over the metal base layers that are over the end surfaces of the body, the four surfaces of the body, or both the end surfaces of the body and the four surfaces of the body; and
   forming a metal cover layer covering at least a portion of the metal base layers and at least a portion of the insulating layer, and contacting the metal base layers at the corners of the body.
<11> The production method of the multilayer ceramic electronic component according to <10>, wherein
   the formation of the insulating layer is performed such that, in a cross-sectional view of the multilayer ceramic electronic component in the first direction, a coverage of the insulating layer on each of the metal base layers is 70% or more.
   <12> The production method of the multilayer ceramic electronic component according to <10> or <11>, wherein
   the formation of the metal base layers includes applying a paste for metal base layer formation from the end surfaces to a portion of the four surfaces, and firing the paste for metal base layer formation,
   the formation of the insulating layer includes applying a paste for insulating layer formation, including glass, to the metal base layers that are over the end surfaces of the body, the four surfaces of the body, or both the end surfaces of the body and the four surfaces of the body, and firing the paste for insulating layer formation, and the formation of the metal cover layer includes applying a paste for metal cover layer formation to at least a portion of the metal base layers and at least a portion of the insulating layer, and firing the paste for metal cover layer formation.

As described above, although the present disclosure has been described based on the specific embodiments and examples, these embodiments and examples are merely provided as examples, and the present disclosure is not limited to the above embodiments and examples. The above embodiments can be practiced in various other forms, and various combinations, omissions, substitutions, additions, modifications, and the like are possible without departing from the intent of the present disclosure. These embodiments and modifications thereof are included in the scope and intent of the present disclosure, and are included in the inventions recited in claims and in a scope of equivalents.

What is claimed is:

1. A multilayer ceramic electronic component, comprising:
a body including a plurality of internal electrodes and a plurality of dielectric layers, laminated in an alternating manner, a pair of end surfaces from which the laminated internal electrodes are respectively exposed in an alternating manner and which face each other in a first direction, four surfaces connected to the end surfaces, and corners between the end surfaces and the four surfaces connected to the end surfaces, in which the dielectric layers include a ceramic as a main component;
a pair of metal base layers extending from the end surfaces to a portion of the four surfaces;
an insulating layer including glass, and disposed over the metal base layers that are over the end surfaces of the body, the four surfaces of the body, or both the end surfaces of the body and the four surfaces of the body; and
a metal cover layer covering at least a portion of the metal base layers and at least a portion of the insulating layer, and contacting the metal base layers at the corners of the body.

2. The multilayer ceramic electronic component according to claim 1, wherein
in a cross-sectional view of the multilayer ceramic electronic component in the first direction, a coverage of the insulating layer on each of the metal base layers is 70% or more.

3. The multilayer ceramic electronic component according to claim 1, further comprising:
a plating layer covering the metal cover layer.

4. The multilayer ceramic electronic component according to claim 1, wherein
the insulating layer is disposed over the metal base layers that are over both the end surfaces of the body and the four surfaces of the body, and
ends of the metal cover layer disposed over the four surfaces of the body are in contact with the body.

5. The multilayer ceramic electronic component according to claim 1, wherein
the insulating layer is disposed over the metal base layers that are over both the end surfaces of the body and the four surfaces of the body,
ends of the metal cover layer disposed over the four surfaces of the body are in contact with the insulating layer, and
the insulating layer disposed over the four surfaces of the body includes a first end and a second end, the first end is located closer to any one of the end surfaces than is the second end, and the second end is exposed from the metal cover layer.

6. The multilayer ceramic electronic component according to claim 1, wherein
the insulating layer is disposed over the metal base layers that are over the end surfaces of the body, and is not disposed over the metal base layers that are over the four surfaces of the body, and
ends of the metal cover layer disposed over the four surfaces of the body are in contact with the body.

7. The multilayer ceramic electronic component according to claim 1, wherein
the insulating layer is disposed over the metal base layers that are over the four surfaces of the body, and is not disposed over the metal base layers that are over the end surfaces of the body, and
ends of the metal cover layer disposed over the four surfaces of the body are in contact with the body.

8. The multilayer ceramic electronic component according to claim 1, wherein
the insulating layer is disposed over the metal base layers that are over the four surfaces of the body, and is not disposed over the metal base layers that are over the end surfaces of the body,
ends of the metal cover layer disposed over the four surfaces of the body are in contact with the insulating layer, and
the insulating layer disposed over the four surfaces of the body includes a first end and a second end, the first end is located closer to any one of the end surfaces than is the second end, and the second end is exposed from the metal cover layer.

9. The multilayer ceramic electronic component according to claim 1, wherein
the glass includes an oxide of silicon as a main component.

10. A production method of a multilayer ceramic electronic component, the production method comprising:
providing a body including a plurality of internal electrodes and a plurality of dielectric layers, laminated in an alternating manner, a pair of end surfaces from which the laminated internal electrodes are respectively exposed in an alternating manner and which face each other in a first direction, four surfaces connected to the end surfaces, and corners between the end surfaces and the four surfaces connected to the end surfaces, in which the dielectric layers include a ceramic as a main component;
forming a pair of metal base layers extending from the end surfaces to a portion of the four surfaces;
forming an insulating layer including glass and disposed over the metal base layers that are over the end surfaces of the body, the four surfaces of the body, or both the end surfaces of the body and the four surfaces of the body; and
forming a metal cover layer covering at least a portion of the metal base layers and at least a portion of the insulating layer, and contacting the metal base layers at the corners of the body.

11. The production method of the multilayer ceramic electronic component according to claim 10, wherein
the formation of the insulating layer is performed such that, in a cross-sectional view of the multilayer ceramic electronic component in the first direction, a coverage of the insulating layer on each of the metal base layers is 70% or more.

12. The production method of the multilayer ceramic electronic component according to claim 10, wherein
the formation of the metal base layers includes
applying a paste for metal base layer formation from the end surfaces to a portion of the four surfaces, and
firing the paste for metal base layer formation,
the formation of the insulating layer includes
applying a paste for insulating layer formation, including glass, to the metal base layers that are over the end surfaces of the body, the four surfaces of the body, or both the end surfaces of the body and the four surfaces of the body, and
firing the paste for insulating layer formation, and
the formation of the metal cover layer includes
applying a paste for metal cover layer formation to at least a portion of the metal base layers and at least a portion of the insulating layer, and
firing the paste for metal cover layer formation.
